(19) United States
(12) Patent Application Publication
(10) Pub. No.: US 2009/0042027 A1
(43) Pub. Date: Feb. 12, 2009

(54) Ruler on a roll

(76) Inventor: Jerry Salvatore Trainello, Sarasota, FL (US)

Correspondence Address: JERRY S. TRAINELLO, 4947 TAYWATER DELL, SARASOTA, FL, 34235, US

(21) Appl. No.: 11/890,659

(22) Filed: Aug. 7, 2007

(51) Int. Cl. B32B 7/12; B29C 65/00

(52) U.S. Cl. 428/343; 156/250; 156/60

(57) ABSTRACT

Ruler on a Roll is a common roll of adhesive or masking tape with the inclusion of ruler indicia (4) on the non-sticky side of the tape. Ruler on a Roll simply requires that you apply a section of the tape (2) to the work surface in the area of your choice. The work surface can be wood, plastic or any flat (12) or curved (14) surface tape will stick to. Once the tape is applied to the material or work surface you immediately have an accurate template as a working guide. The template can be removed and replaced at any time during the work session.

### BACKGROUND OF THE INVENTION

1. Field of Invention

This invention relates to masking tape or adhesive tape, specifically the type of adhesive tape that is removable.

2. Prior Art

Most of us are aware of masking tape or removable adhesive tape.

The applicant is also aware of masking tape with a color code on the package that indicates the tapes particular use or adhesive strength.

The applicant is also aware of U.S. Pat. No. 4,063,878 a process or method of imprinting permanent indicia on adhesive tape for informative purposes.

### BRIEF SUMMARY OF THE INVENTION

We all know and have used masking tape. It a very useful and handy helper for a variety of jobs that removable adhesive tape does best. Masking tape or adhesive tape has a big advantage over other tapes, it can be lifted and removed without marring the surface. I believe this is what led to the wide spread success of masking tape. The basic construction of masking tape has remained the same since its introduction in 1923 by 3M inventor Richard G. Drew.

The present invention Ruler On a Roll is a novel improvement over masking tape. Ruler On a Roll achieves new and useful results that open an entirely new field of use for masking tape. Ruler on a Roll is a common roll of Masking tape with the inclusion of equally spaced indicia on the non-sticky side of the tape.

With this improvement the masking tape can be used as a template or guide for marking a work surface.

The indicia can be in transverse lines or divisions, numbers, letters or symbols. The indicia can also be in the English or Metric system similar to a conventional ruler. In actual manufacture there may be a more efficient, beneficial and practical process or method of transferring permanent indicia onto tape then common printing. The equally spaced indicia may be on the entire roll or a section. The indicia can also be in a variety of colors and sizes or in black and white. The masking tape itself can be manufactured using the same method or process it has been made in the past or any other practical method that removable adhesive or masking tape is made today.

### BRIEF DESCRIPTION OF THE DRAWING

FIG. 1 an enlarged perspective view of the present invention.

FIG. 2 a plan view of a section of the present invention on a flat surface.

FIG. 3 a perspective view of a section of the present invention on a cylinder or round surface.

FIG. 4 an enlarged perspective view of a modified form of the present invention.

### DRAWING—REFERENCE NUMERALS

2—The present invention 4—Transverse indicia 6—Symbol—full circle 8—Symbol—half circle 10—Symbol—quarter circle 12—flat work surface 14—curved work surface

### DETAILED DESCRIPTION OF THE INVENTION

The invention can be further illustrated with reference to the accompanying drawing:

Tape with a new use: As mentioned above, a big advantage of masking tape or adhesive tape is that it can be removed. A rigid conventional ruler, after you measure and mark, can also be removed, the disadvantage is you must physically make the mark. This takes time and, under varying work conditions, can be difficult to do accurately and with certain shapes such as a cylinder, almost impossible.

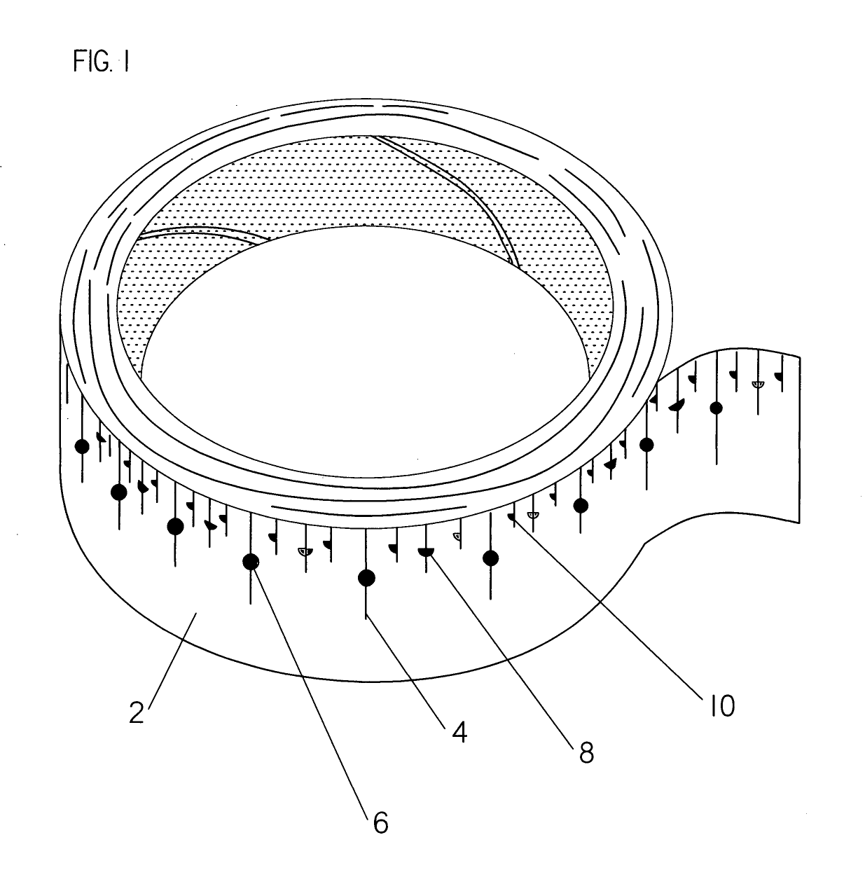

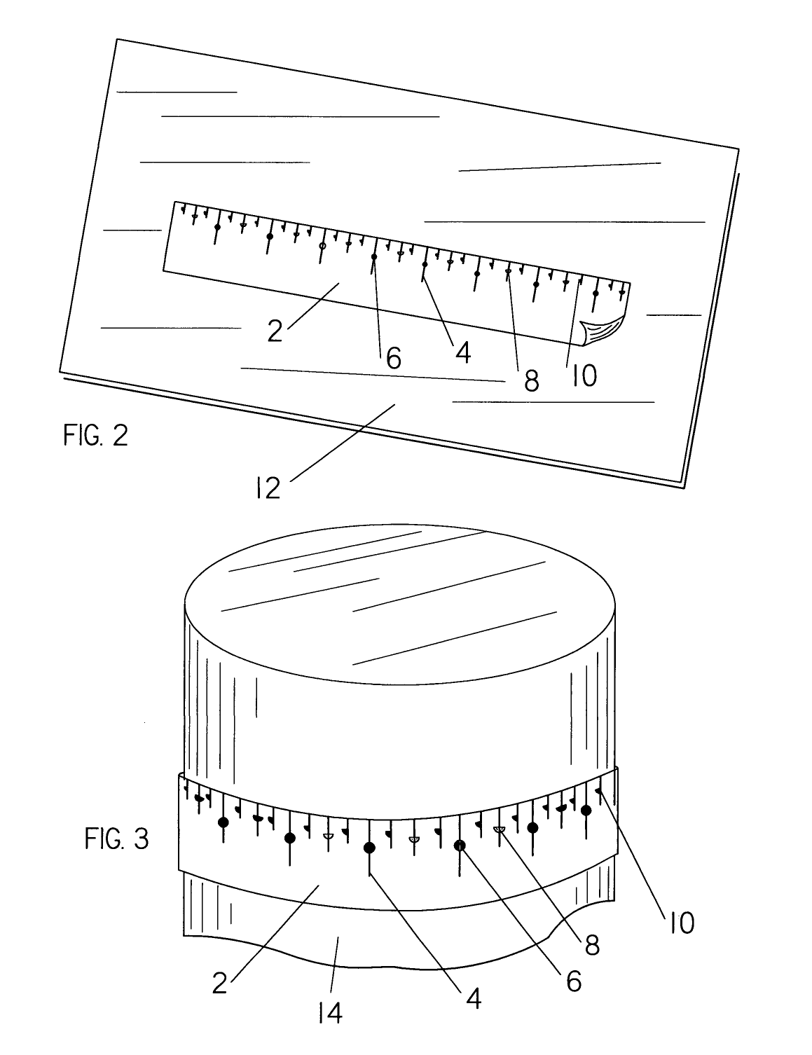

Ruler on a Roll illustrated in FIG. 1 showing the indicia has the flexibility of tape, and simply requires that you apply a section or strip of the tape to the material or work surface in the area of your choice. For convenience, the roll of adhesive tape when made can be scored or serrated or have some other known means for ease of separating into sections. Shown in FIG. 2 is work-surface 12 with a section of Ruler On a Roll numeral 2 on a flat surface ready for use as a layout and guide. The work-piece can be wood, plastic or any other material tape will stick to. Once the masking tape is applied to the material or work areas, you have an accurate template or guide for marking the work surface. Besides the usual transverse measuring indicia shown in FIG. 1 and FIG. 2 numeral 4, here illustrated as representing inches, half inches and quarter inches. For clarity the tape has a full circle numeral 6 a half circle numeral 8 and a quarter circle numeral 10. The full circle represents the inch mark, the half circle represents the half-inch mark, the quarter circle the quarter inch mark and a transverse line would represent the smaller fractions. This arrangement makes it easier to use a section of the tape for marking without getting confused by consecutive numbers.

The shapes can take on many forms such as a dovetail to use as a template for marking and cutting dovetail joinery. The template or guide can be removed at any time during the work session and replaced just as easily. The template is an accurate guide with marks, symbols or transverse unit indicia lines similar to or the same as a ruler. The guide enables a user to easily accomplish a multitude of tasks that would be difficult and time consuming to do with the conventional rigid ruler. Some of these tasks include center punching, drilling, nailing, screwing and fastening of parts.

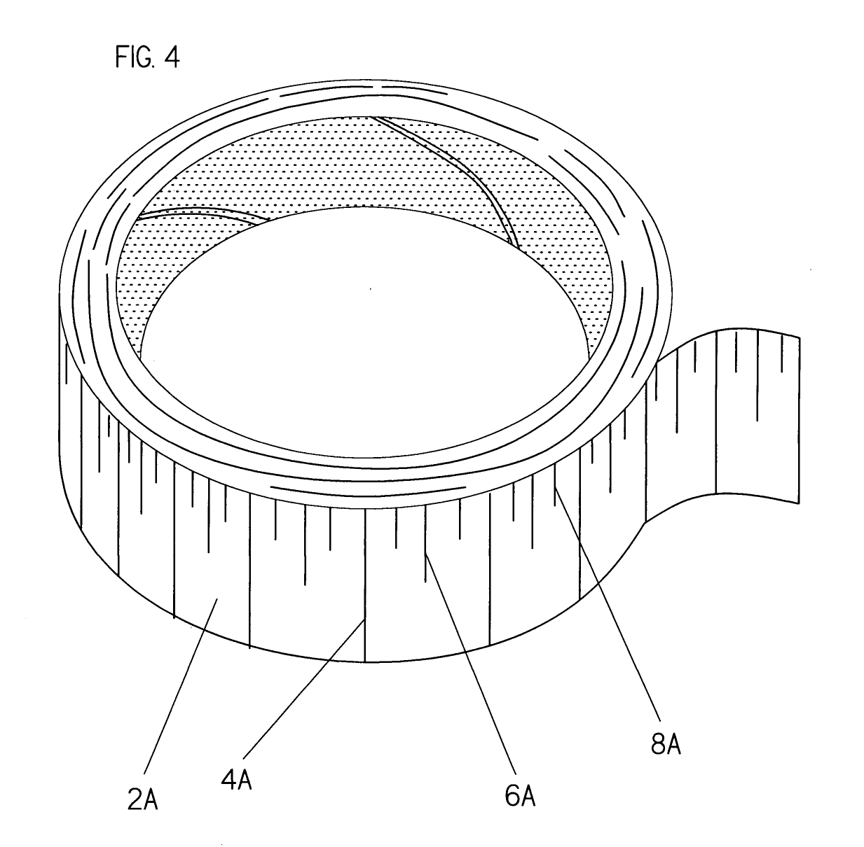

All these tasks can be done easily using the present invention as a working guide. An advantage of tape in performing these tasks is a non-slip surface making it much easier to hold a tool in place for marking and drilling. Additional advantages are the tape helps protect the work-piece and can be applied to a variety of 3-dimensional shapes. Shown in FIG. 3 is a section of Ruler on a Roll numeral 2 on a cylinder or curved surface numeral 14. With the flexibility of the present invention laying out a round or curved surface is as easy as a flat surface. When the job is completed the masking tape can be easily removed.

FIG. 4 numeral 2A I have illustrated a modified form of the present invention. The symbols are removed and transverse unit indicia lines show the measurements. The inch mark is the wide transverse line 4A from one side of the tape to the other. The half-inch mark is 6A from one side of the tape to the middle of the tape, and the quarter inch mark is 8A shown approximately a quarter of the width of the tape. Still another form of the present invention (not illustrated) is to have individual strips or sections of the tape. The sections would have all the indicia on the non-sticky side of the adhesive tape similar to the roll. The appropriate section would be placed on the work surface for marking.

From the description above, a number of advantages become evident when compared to the conventional ruler.

(a) The time consuming method of directly marking a work surface is eliminated.

(b) The work surface is protected from unwanted tool marks.

(c) The tape being a non-skid surface will help hold the point of a tool in place.

(d) The tape can be applied to a curved surface just as easily as a flat surface.

(e) The roll of tape is much more flexible then a rigid ruler.

(f) The user is not dependent on the length of the ruler.

(g) The tape is easily removed.

Where and when to use Ruler on a Roll instead of marking the material itself using the conventional ruler, is limited only by the imagination of the user. Masking tape as an example started out in 1923 to help painters paint a straight border between two colors, today it is used for much more then that.

The foregoing is provided for purposes of illustrating, explaining, and describing embodiments of the present invention. Further modifications and adaptations to these embodiments will be apparent to those skilled in the art and may be made without departing from the scope or spirit of the invention.

I claim:

1. A method of making adhesive tape to use as a guide when marking a work surface;
(a) providing said adhesive tape including,
(b) having equally spaced indicia on the non-sticky side of said adhesive tape,
(c) selecting a work surface,
(d) positioning a section of said adhesive tape on said work surface,
whereby said section of said adhesive tape becomes an accurate guide when marking said work surface.

2. The method of claim 1 wherein said tape is on a roll.

3. The method of claim 2 wherein said roll can have means for ease of cutting into sections.

4. The method of claim 1 wherein said section of said adhesive tape is removable.

5. The method of claim 1 wherein said indicia is transverse unit indicia lines.

6. The method of claim 1 wherein said indicia can include shapes or symbols.

7. A roll of removable adhesive tape; the improvement wherein said tape having equally spaced indicia on the non-sticky side of said tape, to use as a guide for marking a work surface.

8. The roll of adhesive tape of claim 7 wherein said indicia is transverse unit indicia lines.

9. The roll of adhesive tape of claim 7 wherein at least some of said indicia can include symbols or shapes.

10. The roll of adhesive tape of claim 7 wherein said roll can have means for ease of cutting into sections.
